(19) United States
(12) Patent Application Publication
(10) Pub. No.: US 2026/0253080 A1
(43) Pub. Date: Aug. 27, 2026

(54) SYSTEMS AND METHODS FOR FRAUDULENT OPERATION PREVENTION

(71) Applicant: The PNC Financial Services Group, Inc., Pittsburgh, PA (US)

(72) Inventor: Nnamdi Crescent Asogwa, Pittsburgh, PA (US)

(73) Assignee: The PNC Financial Services Group, Inc., Pittsburgh, PA (US)

(21) Appl. No.: 19/375,473

(22) Filed: Oct. 31, 2025

Related U.S. Application Data
(63) Continuation of application No. 19/178,198, filed on Apr. 14, 2025.
(60) Provisional application No. 63/634,163, filed on Apr. 15, 2024.

(51) Int. Cl. G06Q 20/40; G06Q 20/38

(52) U.S. Cl. CPC G06Q 20/4016; G06Q 20/3825; G06Q 20/40145

(57) ABSTRACT

Systems and methods are disclosed for preventing fraudulent operations. In some embodiments, the system or method includes a memory and a processer. Some embodiments include a processor configured to receive pending operation information, the pending operation information corresponding to a secure operation device and including at least one pending operation. In some embodiments, the processor may present an approval request and prompt the user to approve the pending operation and may be further configured to receive a user input including one of an approval or a disapproval of the approval request and upon receiving an approval of the approval request, perform a primary user identity verification to authenticate a user. In some embodiments, the processor may be configured to authorize the pending operation based on the primary user identity verification. In some embodiments, after the operation has been approved and user identity is verified, the system may complete the operation.

### BACKGROUND

Billions of dollars are lost every year as a result of payment card fraud. Often, the victims of payment card fraud are elderly or otherwise fraud-susceptible individuals. Often, card users only recognize that they have been defrauded once their card statement comes due every month—if they even recognize the fraud at all.

When a card user discovers that they are the victim of a fraudulent operation, generally referring to a credit or debit card transaction, the user typically notifies a card provider and initiates a dispute. If the card user is successful in their dispute, the card provider may cover the cost of the fraudulent operation, and the card provider may suffer a financial loss. Additionally, the card provider may suffer a financial loss if the card provider covers the costs of the dispute process (by, e.g., paying employees to investigate the alleged fraud). Thus, the card provider may lose money every time a user disputes a fraudulent operation. Additionally, the card user may suffer due to the stress involved in managing and responding to fraudulent transactions and may expend time during the fraud investigation process.

Despite efforts by card providers to recognize and flag suspicious operations, countless instances of payment card fraud slip past card providers. Artificial intelligence models directed to fraud elimination may be based on historic user behavior, which has its limits. For example, a user may often shop at a certain store in a certain town. If a fraudulent operation is made at the store, then it is less likely that the artificial intelligence models would identify the operation as fraudulent. In another example, a user could make a purchase that breaks historic trends on how or where the user typically spends money because the user may be on vacation. Such an operation may be flagged by artificial intelligence models as fraudulent, even though the transaction was made by the user. The artificial intelligence models try to predict future user behavior based on past user behavior, but the models may not always be accurate. In addition, building and updating artificial intelligence models poses financial costs that may not be sustainable. Therefore, a cost-effective, sustainable, and accurate solution is needed to address payment card fraud, especially in instances where card holders are especially susceptible to payment card fraud.

The disclosed systems and methods provide a solution for preventing fraudulent operations. The disclosed embodiments provide a solution that allows a user to authorize a pending operation and pass a user identity verification before the pending operation is completed. Through the user approval and user identity verification process, the card provider limits liability for fraudulent operations, and the user avoids fraudulent operations. By preventing more fraudulent operations from occurring, the disclosed systems and methods for preventing fraudulent operations drastically lower the number of disputed operations, saving the user and the card provider the costs of both the fraud itself and the costs of the dispute process, as well as saving the user the stress of disputing potential fraudulent operations.

### SUMMARY

In an embodiment described herein, a system for preventing fraudulent transactions is disclosed. The system may include at least one memory for storing instructions and at least one processor of a server in communication with the at least one memory. The at least one processor may be configured to execute the stored instructions to receive, from a remote server, pending operation information, the pending operation information corresponding to a secure operation instrument and including at least one pending operation. According to some embodiments, the secure operation instrument may be associated with a secure token and the pending operation may occur at the terminal. The system may further include a processor configured to request, from the terminal, identifying information required to use the secure token; and present, on a user device associated with the secure operation instrument, an approval request to approve the at least one pending operation. The system may further include a processor configured to receive a user input including one of an approval or a disapproval of the approval request, and upon receiving an approval of the approval request, perform a primary user identity verification to authenticate a user. The processor may be further configured to authorize the pending operation based on the primary user identity verification if the primary user identity verification authenticates the user. The processor may be further configured to request a secondary user identity verification if the primary user identity verification does not authenticate the user and perform the secondary user identity verification. Upon performing the secondary user identity verification, the processor may be further configured to block the at least one pending operation if the secondary user identity verification does not authenticate the user based on the identifying information associated with the secure token. Upon performing the secondary user identity verification, the processor may be further configured to complete the at least one pending operation if the secondary user identity verification authenticates the user based on the identifying information associated with the secure token; and transmit, to the terminal, a status of the pending operation based on whether the user is authenticated.

According to some embodiments, the pending operation information may include at least one chosen from the set of: one or more operator names, a pending operation amount, a pending operation location, a pending operation time, or a pending operation date.

According to some embodiments, the processor may further be configured to display a pending approval request interface including a list of all pending approval requests, each approval request on the list corresponding to at least one pending operation.

According to some embodiments, the processor may be configured to receive selection of at least one pending operation from the list of all pending approval requests for approval or disapproval.

According to some embodiments, the secure operation device may be associated with a user digital record.

According to some embodiments, the identity verification may be biometric identity verification and may include a facial recognition scan, a fingerprint scan, a retina scan, an iris scan, or voice recognition.

According to some embodiments, the secondary user identity verification may be a password verification.

According to some embodiments, the approval request may be a push notification on the user device configured to communicate the pending operation information to the user.

According to some embodiments, the processor may be further configured to display the approval request via a text notification on the user device.

According to some embodiments, the approval request may be communicated via an auditory notification by the user device.

According to some embodiments, the user input may be a touch input.

According to some embodiments, the user input may be an auditory input.

According to some embodiments, the system may include a timer configured to begin running upon receipt of the pending operation information; and the processor may further be configured to execute the stored instructions to block the pending operation if the timer exceeds either a predetermined operation approval period or a predetermined user identity verification period.

According to some embodiments, based on an operation history, the at least one processor may designate at least one recurring operation as exempt from requiring user approval.

According to some embodiments, the at least one processor may be configured to receive an operation amount threshold, the operation amount threshold being configured to exempt operations of an amount lower than the operation amount threshold from requiring user approval.

In an embodiment disclosed herein, a method for preventing fraudulent transactions is disclosed. The method may include receiving, from a remote server, pending operation information, the pending operation information corresponding to a secure operation device and including at least one pending operation. According to some embodiments, the secure operation device may be associated with a secure token and the pending operation may occur at a terminal. The method may further include requesting, from the terminal, identifying information required to use the secure token and presenting, on a user device associated with the secure operation device, an approval request to authorize the at least one pending operation and receiving a user input either approving or disapproving the approval request. Upon receiving an approval of the approval request, the method may include performing a primary user identity verification to authenticate a user and authorizing the pending operation based on the primary user identity verification if the primary user identity verification authenticates the user. The method may further include, requesting a secondary user identity verification if the primary user identity verification does not authenticate the user and performing the secondary user identity verification. Upon performing the secondary user identity verification, the method may further include blocking the at least one pending operation if the secondary user identity verification does not authenticate the user based on the identifying information associated with the secure token. Upon performing the secondary user identity verification, the method may further include completing the at least one pending operation if the secondary user identity verification authenticates the user based on the identifying information associated with the secure token; and transmitting, to the terminal, a status of the pending operation based on whether the user is authenticated.

In an embodiment disclosed herein, a system for preventing fraudulent debit transactions is disclosed. In an embodiment, the system for preventing fraudulent debit transactions may include at least one memory for storing instructions and at least one processor of a server in communication with the at least one memory. The at least one processor may be configured to execute the stored instructions to receive, from a third-party server, pending debit transaction information. The pending debit transaction information may correspond to a debit card and may include at least one single pending debit transaction, wherein a debit card user may have already input a correct debit Personal Identification Number (PIN). The at least one processor may be configured to cause a user device to present an approval request to approve at least one single pending debit transaction and receive a user input. The user input may include one of an approval or a disapproval of the approval request. In some embodiments, upon receiving an approval of the approval request, the at least one processor may be configured to perform a real-time user identity verification. The real-time user identity verification may be a biometric identity verification. The at least one processor may be configured to authorize the at least one single pending debit transaction based on the real-time user identity verification. The at least one processor may be configured to deny the at least one single pending debit transaction if the real-time user identity verification fails. The at least one processor may be configured to complete the at least one single pending debit transaction if the real-time user identity verification is approved.

According to some embodiments, the pending debit operation information may include at least one of one or more operator names, a pending debit operation amount, a pending debit operation location, a pending debit operation time, or a pending debit operation date.

According to some embodiments, the operations may further cause the processor to display a pending approval request interface including a list of all pending approval requests, each approval request on the list corresponding to at least one pending debit operation.

According to some embodiments, the pending approval request interface may be configured to receive selection of at least one pending debit operation from the list of all pending approval requests for approval or disapproval.

According to some embodiments, the biometric identity verification may include at least one of a facial recognition scan, a fingerprint scan, a retina scan, an iris scan, or voice recognition.

According to some embodiments, the approval request may be a push notification on the user device configured to communicate the pending debit operation information to the user.

According to some embodiments, the approval request may be communicated via a text notification on the user device.

According to some embodiments, the approval request may be communicated via an auditory notification by the user device.

According to some embodiments, the user input may be a touch input or an auditory input.

According to some embodiments, the at least one pending debit operation may be denied if a predetermined operation approval period lapses.

According to some embodiments, the at least one processor may designate at least one recurring operation as exempt from requiring user approval.

According to some embodiments, the at least one processor may be configured to receive an operation amount threshold configured to exempt operations of an amount lower than the operation amount threshold from requiring user approval.

### BRIEF DESCRIPTION OF FIGURES

FIG. 1 is an illustration of a defrauded individual desiring a system for fraud prevention, consistent with disclosed embodiments.

FIG. 2 is a schematic diagram illustrating an exemplary fraudulent operation detection system.

FIG. 3A is a flowchart illustrating an exemplary fraudulent operation detection system.

FIG. 3B is a flowchart illustrating an exemplary fraudulent operation detection system.

FIG. 4 is a schematic diagram illustrating an exemplary system for preventing fraudulent operations, consistent with disclosed embodiments.

FIG. 5 is a flowchart illustrating an exemplary method for preventing fraudulent operations, consistent with disclosed embodiments.

FIG. 6 is a flowchart illustrating an exemplary method for flagging an operation as potentially fraudulent, consistent with disclosed embodiments.

FIG. 7 is a flowchart illustrating an exemplary method for preventing fraudulent debit operations, consistent with disclosed embodiments.

FIG. 8 is a schematic diagram illustrating exemplary components of computer hardware used for fraud prevention, consistent with disclosed embodiments.

FIG. 9 is an illustration of a user device displaying a system for preventing fraudulent operations, consistent with disclosed embodiments.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of systems, apparatuses, and methods consistent with aspects related to the present disclosure as recited in the appended claims.

Fraudulent operations can cost consumers, card providers, and other operation-facilitating companies significant financial losses. Operations generally refer to, but are not limited to, credit and debit card transactions. Fraudulent operations often occur when a fraudster obtains an individual's debit card, charge card, or banking information. For example, if a fraudster obtains an individual's card or banking information, then the fraudster could use that information to make a fraudulent operation. An individual often has no way of knowing that the fraudulent operation has occurred until the money has already been transferred from their account. Even if the individual disputes the operation, there is no guarantee that the individual will receive a refund. If an operation facilitator issues the individual a refund, then the operation facilitator may suffer a loss. In a non-limiting example, an operation facilitator may be a financial institution. Financial institutions may include banks, lenders, credit unions, charge card providers, and other institutions that facilitate operations including, but not limited to credit transactions, debit transactions, wire transfers, and other digital transfers of money.

Some individuals have a higher risk of being the target of fraudulent operations. These high-risk individuals may be elderly, incapacitated, or careless. Individuals prone to fraudulent operations, and the card providers and operation-facilitating companies that provide services to them, could benefit from implementing fraudulent operation prevention systems. As a non-limiting example, an elderly individual may lower their fraud susceptibility by approving all operations made using their personal financial accounts. By personally approving all operations made, the elderly individual may be more aware of operations made using their personal accounts, and the elderly individual can deny any operation that they did not make.

In another non-limiting example, an adult child, a guardian, or a conservator can set up an account for an elderly person. The adult child, guardian, or conservator would be an account owner, and any operation made by the elderly person may need approval from the from the account owner.

In another non-limiting example, a parent may have multiple physical debit cards associated with a parent user account. This may enable the parent of a child to provide the child with one of the physical debit cards, while maintaining control of operation approval. In this example, operations made by the child of the parent using one of the physical debit cards may be subject to approval by the parent.

The systems and methods disclosed herein may limit card provider liability by requiring approval by the user for operations that are not preset by the user as exempt operations. Because non-exempt operations may require user approval, the user may have the opportunity to disapprove all fraudulent operations.

The present disclosure relates to a fraudulent operation prevention system for account users, including, for example, individuals who are at a high risk of falling victim to fraudulent operations.

In the following detailed description, numerous specific details are set forth in order to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are not constrained to a particular order or sequence or constrained to a particular system configuration. Additionally, some of the described embodiments or elements thereof can occur or be performed simultaneously, at the same point in time, or concurrently.

Reference will now be made in detail to the disclosed embodiments, examples of which are illustrated in the accompanying drawings.

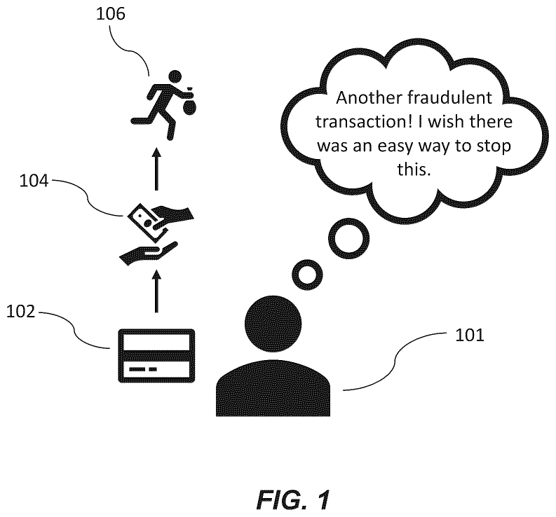

FIG. 1 is an illustration of a defrauded individual 101 desiring a system for fraud prevention. An operation device 102, owned by the defrauded individual 101, was used to make a fraudulent operation 104. The fraudulent operation 104 was made by a fraudster 106. By the time the defrauded individual 101 realized the fraudulent operation 104 occurred, it may be too late to stop the operation. The defrauded individual 101 may desire a system to better prevent fraudulent operations 104.

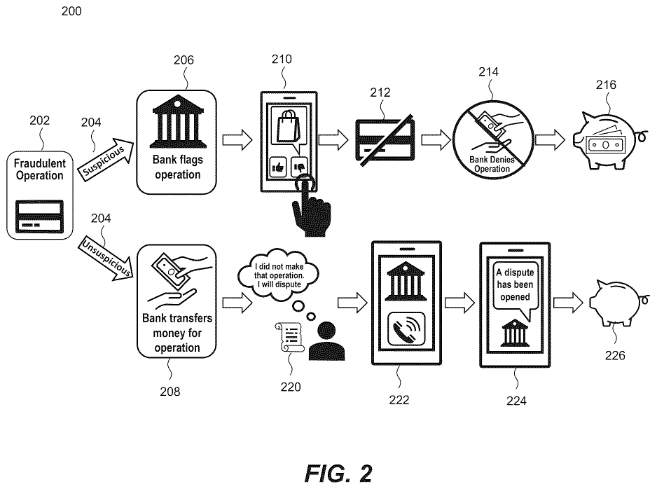

FIG. 2 is a schematic diagram illustrating an exemplary fraudulent operation detection system 200. At step 202, a fraudulent operation may be initiated. The fraudulent operation goes through an evaluation step 204 to determine if the fraudulent operation is suspected of being fraudulent. In one embodiment, at step 204 the operation may be flagged as suspicious and proceed to step 206. In another embodiment, at step 204 the operation may be flagged as unsuspicious and proceed to step 208. If the fraudulent operation is suspected of being fraudulent at the evaluation step 204, at step 206, the financial institution flags the fraudulent operation as suspected of being fraudulent. At step 210, the financial institution may send a notification to an account user, alerting the account user of the fraudulent operation, and prompting the account user to authorize or disapprove the fraudulent operation. The account user disapproves the fraudulent operation, and at step 212, the account user's denial of the fraudulent operation may be communicated to the financial institution. At step 214, the financial institution cancels the fraudulent operation, and the account user does not lose money as the fraud has been thwarted. The money remains in the account user's account at step 216.

If the fraudulent operation is not flagged as being suspicious at step 204, and is instead flagged as being unsuspicious, the financial institution may transfer the funds to complete the fraudulent operation at step 208. At step 220, the account user receives their monthly statement, recognizes the fraudulent operation, and decides to dispute the fraudulent operation with the financial institution. At step 222, the account user contacts the financial institution and initiates the dispute process. At step 224, the financial institution begins the dispute process. After a successful dispute process, however, the fraudulent transaction cannot be undone, and the financial institution suffers a loss from reimbursing the user at step 226.

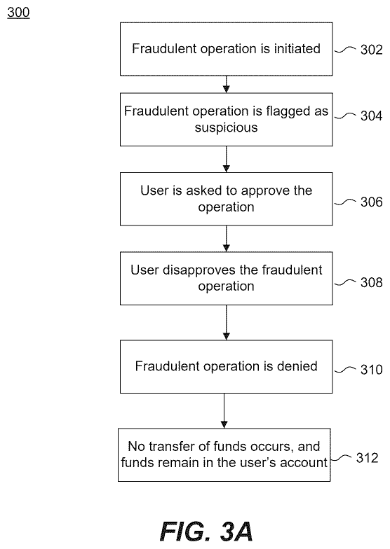

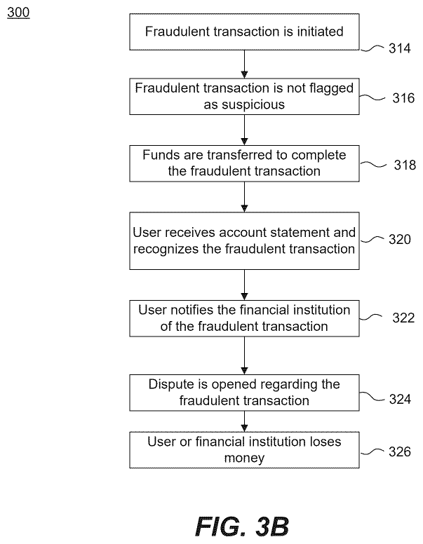

FIG. 3A is a flowchart diagram illustrating an exemplary fraudulent operation detection method 300. At step 301, a fraudulent operation may be initiated by a fraudster with access to a user's account information. At step 302, the fraudulent operation may be flagged as suspicious. At step 303, the user may be prompted to authorize the fraudulent operation. At step 304, the user may disapprove the fraudulent operation. At step 305, after receiving user disapproval, the fraudulent operation may be denied. At step 306, the fraudulent operation has been prevented and no transfer of funds occurs. The funds remain in the user's account. The steps shown in method 300 may be completed only if the operation is flagged as suspicious in step 302. Thus, if the operation is not flagged as suspicious at step 302, the fraudulent operation may be successful.

FIG. 3B is a flowchart diagram illustrating an exemplary fraudulent operation detection method 308. At step 314, a fraudulent operation may be initiated. At step 316, the fraudulent operation may be flagged as unsuspicious. At step 318, funds may be transferred, and the fraudulent operation may be completed. At step 320, a user may receive an account statement and recognize the fraudulent operation. At step 322, the user may notify the financial institution of the fraudulent operation. At step 324, a dispute may be opened regarding the fraudulent operation. At step 326, regardless of the outcome of the dispute process, one of the parties may lose money. If the financial institution reimburses the user, then the financial institution may lose money, and if the financial institution does not reimburse the user, then the user may lose money. Thus, a solution is needed through which a user approves or disapproves an operation before funds are transferred.

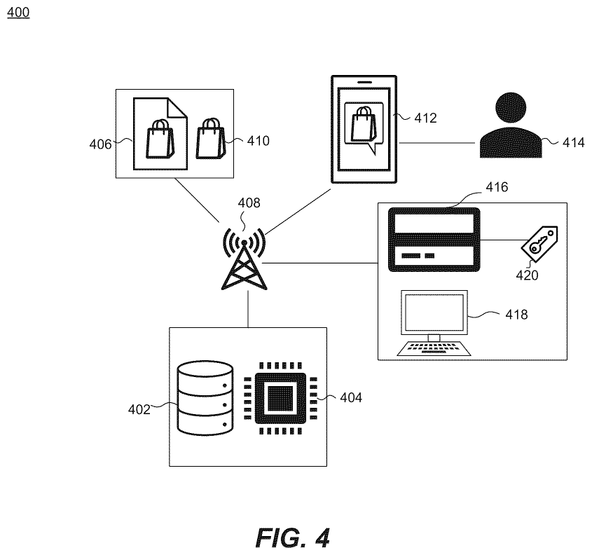

FIG. 4 is a schematic diagram illustrating an exemplary system 400 for preventing fraudulent transactions, consistent with disclosed embodiments. In some embodiments, system 400 includes at least one memory 402 for storing instructions and at least one processor 404 in communication with the at least one memory 402. Both memory 402 and processor 404 may be associated with a server.

As referred to herein, a memory, such as memory 402, may include any type of computer-readable storage medium. A computer-readable storage medium may store instructions for execution by at least one processor, such as processor 404, including instructions for causing the processor to perform steps or stages consistent with disclosed embodiments. Additionally, one or more computer-readable storage mediums may be utilized in implementing a computer-implemented method. The term computer-readable storage medium should be understood to include tangible items and exclude carrier waves and transient signals. Furthermore, memory 402 may include one or more storage devices configured to store data for use by system 400. Memory 402 may include, but is not limited to, a hard drive, a solid-state drive, a CD-ROM drive, a peripheral storage device (e.g., an external hard drive, a USB drive, etc.), a network drive, a cloud storage device, or any other storage device.

As referred to herein, a processor may be any type of computing device capable of executing instructions. A processor, such as processor 404 may take the form of, but is not limited to, a microprocessor, embedded processor, or the like, or may be integrated in a system on a chip (SoC). Furthermore, according to some embodiments, processor may be from the family of processors manufactured by Intel®, AMD®, Qualcomm®, Apple®, NVIDIA®, or the like. The processor may also be based on the ARM architecture, a mobile processor, or a graphics processing unit, etc.

In some embodiments, at least one processor 404 associated with a remote server may be configured to execute instructions stored on memory 402 associated with the server. In some embodiments, system 400 may receive pending operation information 406 from a remote server connected to network 408. As referred to herein, a remote server may be third-party server (e.g., a web server, application server, virtualized server, etc.), that is owned by a different entity than the owner of system 400. As referred to herein, a server may also include one or more dedicated processors and/or memories and may be configured to store files accessible through a network. In some embodiments, pending operation information 406 may correspond to a pending operation 410. As referred to herein, a pending operation may be any operation that has been initiated but not yet completed. An operation may be completed when funds have been transferred. In some embodiments, pending operation information 406 may include at least one of one or more operating party names (i.e., operator names), a pending operation amount, a pending operation location, a pending operation time, or a pending operation date.

In some embodiments, processor 404 may be configured to display information on user device 412. User device 412 may be for example, a smart phone, a mobile phone, a laptop, a tablet computer, a wearable computing device, a personal computer (PC), and/or a smart television. User device 412 may be configured to communicate with processor 404 and may be configured to receive commands from user 414.

System 400 may also include a secure operation device, such as secure operation device 416, and a terminal, such as terminal 418. A secure operation device may refer to any operation device used to initiate an operation—generally a financial transaction—that is configured to be part of a system for preventing fraudulent operations, such as system 400. In some embodiments, secure operation device 416 may be a debit card. In some embodiments, secure operation device 416 may be a charge card. In some embodiments, secure operation device 416 may be a bank transfer card. In some embodiments, secure operation device 416 may be an electronic payment method. Some examples of electronic payment methods that may be used in system 400 include, but are not limited to, electronic debit cards, electronic credit cards, and electronic transfer systems such as PAYPAL and VENMO. In some embodiments, information corresponding to the secure operation device may be shared with different businesses or third parties, such that the secure operation device may be charged for subscriptions, recurring payments, or other charges. For example, debit or credit card information could be shared with an entertainment streaming service and the debit card or the credit card could be charged each month for a monthly entertainment streaming subscription.

Consistent with disclosed embodiments, operations initiated using secure operation device 416 may be communicated over network 408 via terminal 418. A terminal may refer to any device or medium configured to interface or accept payment cards to make electronic transactions. In some embodiments, terminal 418 may be a credit card reader, debit card reader, or a website used to make a purchase. In one example, terminal 418 may be a point-of-sale terminal, and a user may make a transaction using secure operation device 416. In another example, terminal 418 may be a website, and a user may use secure operation device 416 to make a transaction on the website.

In some embodiments, secure operation device 416 may be associated with a secure token 420. A secure token may refer to a digital device that provides security when accessing certain information, e.g., bank or credit card information, and is often used for authentication. A secure token may include a series of numeric and/or alphanumeric characters and may be configured to allow a terminal (such as, for example, terminal 418) to identify the secure token and recognize an entity associated with the token, such as, for example, user 414, or the user's bank. A secure token, such as, for example, secure token 420, may substitute a sensitive data element, such as a user's name, address, credit card number, debit card number, bank account number, or routing number, with a non-sensitive equivalent, referred to as a token, that has no intrinsic or exploitable meaning or value. The secure operation device (such as, for example, secure operation device 416) may be associated with a secure token (such as, for example, secure token 420).

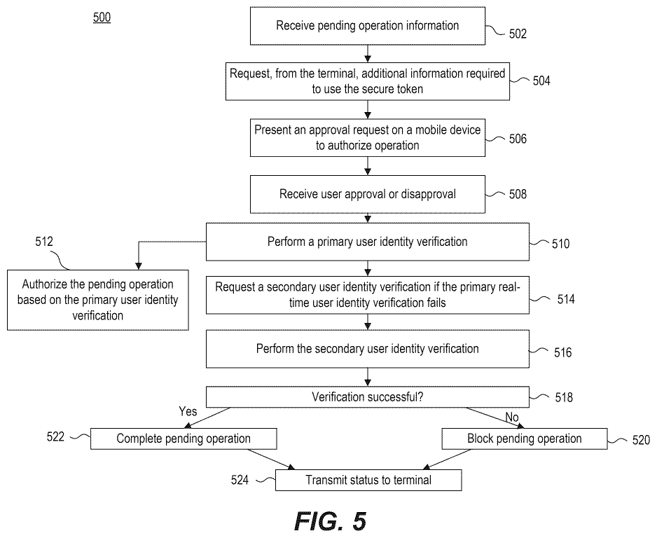

FIG. 5 is a flow chart illustrating one embodiment of a method 500 for preventing fraudulent operations, consistent with disclosed embodiments. At least one processor (such as, for example, processor 404 described in reference to FIG. 4) may perform the operations disclosed in method 500. At step 502, the processor may receive, from a remote server, pending operation information, such as pending operation information 406, described in reference to FIG. 4. Consistent with disclosed embodiments, the pending operation (such as, for example, pending operation 410) may correspond to a secure operation device (such as, for example, secure operation device 416) and include at least one pending operation (such as, for example, pending operation 410).

At step 504, the at least one processor may request, from the terminal, identifying information required to use the secure token. Identifying information may include, for example, a user's name, address, credit card number, debit card number, bank account number, bank account routing number, wallet identifier, and/or device identifier.

At step 506, the at least one processor may present, on a user device (such as, for example, user device 412), an approval request to authorize the pending operation. Consistent with disclosed embodiments, the operation may be genuine (or non-fraudulent), or fraudulent. As described in reference to step 502, the approval request may contain pending operation information, such as, for example, pending operation information 406.

In some embodiments, the approval request may be presented on the user device in response to a prompt received from a server, for example, server 402 as described in FIG. 4. In some embodiments, the server may present the approval request via a web browser on a user device (e.g., user device 412) or via an application running on the user device. In some embodiments, the approval request may communicate the pending operation information to the user. In some embodiments, the approval request may be a push notification on the user device that communicates the pending operation information to the user. In some embodiments the approval request may be communicated to the user via a text notification on the user device. A text notification may be any notification where information is communicated via written words, symbols, or pictures displayed on the user device. In some embodiments, the approval request may be communicated to the user via an auditory notification by the user device. An auditory notification may be any notification where information is communicated via sounds produced by the user device.

At step 508, the at least one processor (such as, for example, processor 404) may receive a user input. In some embodiments, the user input may include approval or disapproval of the approval request. In some embodiments, the user input may be a touch input. For example, the touch input may include the user touching, with their finger, a portion of the graphical user interface of the user device, said portion of the graphical user interface corresponding to the approval request. The input may be in a mobile or web application specific to a card provider, may be in response to a notification associated with an application specific to a card provider, or may be in response to an email or text message. In some embodiments, the user input may be an auditory input. For example, the auditory input may include a user vocally responding to the approval request to authorize or disapprove the pending operation, such as, for example, on a phone call.

At step 510, a processor (such as, for example, processor 404) may perform a primary real-time user identity verification. In some embodiments, the primary real-time user identity verification may include a biometric identity verification. The biometric identity verification may be performed with one or more sensors and/or one or more optical lenses. In some embodiments, the biometric identity verification may include at least one of a facial recognition scan, a fingerprint scan, a retina scan, an iris scan, or voice recognition. A facial recognition scan may be a biometric identity verification technique where the face of the user is scanned and compared to a previously recorded facial scan of the user to verify a user identity. A fingerprint scan may be a biometric identity verification technique where one or more fingerprints of the user is scanned and compared to a previously recorded fingerprint scan of the user to verify a user identity. A retina scan may be a biometric identity verification technique where the retina of the user is scanned and compared to a previously recorded retinal scan of the user to verify user identity. An iris scan may be a biometric identity verification technique where the iris of the user is scanned and compared to a previously recorded iris scan of the user to verify a user identity. Voice recognition may be a biometric identity verification technique where the voice of the user is recorded and compared to a previously recorded recording of the user's voice to verify a user identity. In some embodiments, the primary real-time user identity verification may include a password or pin associated with the user's account and/or user device.

Consistent with disclosed embodiments, the user's device, such as, for example, user device 412, may be configured to perform the identity verification. To perform the identity verification, the user device may include at least one of a biometric sensor, a camera configured to detect one or more physical attributes unique to an individual, a microphone configured to verify the user's voice, or a fingerprint scanner configured to verify the user's fingerprint. A biometric sensor may refer to a mechanical or electrical device that captures biometric data (i.e., a user's face, palm print, and/or iris) digitally in a way that can be turned into a biometric template. The biometric sensor may include a camera configured to detect one or more physical attributes unique to an individual, a microphone configured to verify the user's voice, and/or a fingerprint scanner configured to verify the user's fingerprint.

At step 512, the processor may authorize the pending operation based on a successful primary user identity verification. The primary user identity verification may be performed in real-time. A successful primary real-time user identity verification may refer to a successful authentication of a user's features. For example, the biometric sensor associated with user device 412 may successfully authenticate a user's face, fingerprint, and/or voice.

If the primary real-time user identity verification is not successful, the processor may, at step 514, request a secondary real-time user identity verification. The primary real-time user authentication may not be successful when, for example, the biometric sensor fails to authenticate a user's face, voice, or fingerprint. In some embodiments, the secondary real-time user identity verification may include a password or pin verification. Additionally or alternatively, the secondary real-time user identity verification may include a biometric identity verification. In some embodiments, the secondary real-time user identity verification may be the same method used for the primary real-time user identity verification or may be an alternate method. Alternatively, the processor (such as, for example, processor 404) request a secondary user identity verification based on information associated with the secure token, for example secure token 420 associated with secure operation device 416.

At step 516, the processor may perform the secondary real-time user identity verification. In some embodiments, performing secondary real-time user identity verification may include presenting, on a user device (such as, for example, user device 412), a password prompt. In some embodiments, the password prompt may prompt user 414 to enter a password that user 414 has previously set. In some embodiments, processor 404 may require that user 414 enter a correct password into the password prompt to complete secondary real-time user identity verification. In some embodiments, if user 414 enters the correct password, then the secondary real-time user identity verification may be a successful real-time user identity verification. In some embodiments, processor 404 may be configured to receive a user password input and verify the password input. In some embodiments, verifying the user password input may comprise matching the user password input to the password that user 414 has set.

At step 518, processor 404 may determine whether verification was successful. At step 520, the processor (such as, for example, processor 404) may, upon performing the secondary user identity verification, block the at least one pending operation if the secondary user identity verification does not authenticate the user based on the identifying information associated with the secure token, such as secure token 420. In some embodiments, upon denial of pending operation 410, processor 404 may be configured to notify a transacting party in real time that the pending operation 410 has been denied. An operating party may be one or more individuals, an organization, or groups of individuals who interact with a user, such as, for example user 414. An operating party may also interact with a bad actor or fraudster posing as user 414.

At step 522, at least one processor may, upon performing the secondary user identity verification, complete the pending operation if the secondary user identity verification authenticates the user based on identifying information associated with the secure token. In some embodiments, processor 404 may be configured to initiate a transfer of funds from a user digital record to the transacting party to complete pending operation 410. A user digital record may refer to information or an account that is associated with a particular user. A user digital record may be an account where a user (such as, for example, user 414) stores funds, for example a digital banking account, a digital wallet, or a similar account.

Regardless of whether the processor completes or blocks the pending operation, the processor may, at step 524, transmit, to the terminal, a status of the pending operation based on whether the user is authenticated. The status of the pending operation may refer to whether the processor blocked or completed the operation.

Consistent with disclosed embodiments, system 400 may include a timer configured to begin running upon receipt of the pending operation information. The timer may be a digital stopwatch, time switch, and/or built in software timer configured to measure elapsed time. In some embodiments, system 400 may include a predetermined operation approval period and a predetermined user identity verification period. In some embodiments, the processor (such as, for example, processor 404) may be configured to, at step 520, block the pending operation if the timer exceeds either the predetermined operation approval period or the predetermined user identity verification period. In some embodiments, a predetermined operation approval period may be a period of time between the presentation of the approval request and the reception of the user input approving the pending operation. For example, if the predetermined operation approval period is set for 24 hours, then 24 hours after the presentation of the approval request, the pending operation may be denied unless the user approves the pending operation before the 24-hour period lapses. In some embodiments, the predetermined operation approval period may be set by the user. In some embodiments, the predetermined operation approval period may be preset by an operation facilitator.

In some embodiments, the predetermined user identity verification period may be a period of time between the reception of the user input approving the pending operation and a successful user identity verification. For example, if the predetermined user identity verification period is set for 24 hours, then 24 hours after the reception of the user input approving the pending operation, the pending operation may be denied unless the user identity verification is successful before the 24-hour period lapses.

In some embodiments, the processor, (such as, for example, processor 404) may designate certain recurring operations as exempt from user approval. The processor may be configured to receive user input designating certain recurring operations as exempt from user approval. For example, if a user (for example, user 414) has a recurring car insurance payment that they are charged each month, user 414 may preset the operation as exempt from method 500 because the payment is identical from month to month. Processor 404 may be configured to receive and store user 414's selection—i.e., designating their car payment as a recurring one exempt from user verification—in memory 402. A length of time, e.g., one month, may pass, and the user may make a subsequent car payment. Processor 404 may be configured to compare the subsequent car payment information with the stored car payment information and may determine that the operation is recurring because the subsequent car payment is identical to the stored car payment. In another example, user 414 may opt to authorize recurring payments each month.

In another embodiment, processor 404 may be configured to analyze one or more user operations to determine whether any qualify as recurring. A recurring operation refers to an operation that a user makes at the same time over a certain length of time, and a subsequent operation may have the same operation amount as the previous operation. For example, a recurring operation may be a car payment. The car payment may be the same amount and may occur at the same time each month.

Processor 404 may determine that one or more recurring operations are eligible for exemption. In this example, processor 404 may be configured to store in memory 402 recurring payment information, here, a car payment. In this example, a user (such as, for example, user 414) does not initially designate the recurring car payment as exempt. In other words, a user may designate some recurring transactions as exempt, but not the car payment. Processor 404 may be configured to store in memory 402 metadata associated with a first payment, here, the car payment, including, for example, the date the first payment was made, the timestamp associated with the first payment, to whom the first payment was made, the IP address associated with the first payment, and the first payment amount. In this example, the user may make an identical subsequent payment, for example, one month after the first payment. Processor 404 may store in memory 402 metadata associated with the identical subsequent payment (here, the car payment), such as the date the second payment was made, the timestamp associated with the second payment, to whom the second payment was made, the IP address associated with the second payment, and the second payment amount. Processor 404 may be configured to compare the first payment and the second payment and may determine that the first payment and the second payment are identical except for their transaction dates. In this example, the processor may determine that the user's first and second car payments are identical except for their transaction dates. Accordingly, processor 404 may be configured to prompt user 414 to designate the car payment as exempt from method 500. Processor 404 prompting a user to designate recurring payments as exempt saves the user time and hassle because the user no longer needs to spend time designating certain recurring operations as exempt, and method 500 still protects the user from fraud. In another example, processor 404, based on a determination that the user's first and subsequent payments are identical except for their transaction dates, may automatically designate a recurring operation as exempt, without user input.

In some embodiments, the user may be required to provide pre-authorized operation information to identify exempt operations. In some embodiments, the pre-authorized operation information may include at least one of one or more operating party names, an operation amount, an operation location, an operation time, and/or an operation date for the exempt operation. In some embodiments, processor 404 may determine whether incoming pending operation information matches the pre-authorized operation information. In some embodiments, if the pending operation information does not match the pre-authorized operation information, processor 404 may re-run the pending operation for approval. In some embodiments, if the pending operation information matches the pre-authorized operation information, processor 404 may authorize the pending operation without running the pending operation through method 500 again.

In some embodiments, processor 404 may be configured to present potential pre-authorized operation information to the user to assist the user in identifying exempt operations. In this example, processor 404 analyzes an incoming operation and data associated with the operation, for example, one or more transacting party names, an operation amount, an operation location, an operation time, or an operation date for the exempt operation. Processor 404 may be configured to present this information to a user (such as, for example, user 414), wherein the user may identify the operation as exempt. Processor 404 is configured to receive user 414's input.

In some embodiments, processor 404 may store in memory 402 multiple operations that a user makes over a length of time. For example, processor 404 may store in memory 402 all operations a user makes over a week, two weeks, a month, two months, and/or a year. Based on the user's operation behavior, processor 404 may be configured to provide the user with a list of potential exempt recurring operations. For example, a user may enroll in a streaming service, which charges the user an identical amount each month. Processor 404 may be configured to store data associated with the streaming service in memory 402, including, for example, the timestamp associated with the operation, the operation amount, the operation date, and the operation recipient. Processor 404 may be configured to analyze subsequent payments and may determine that the payments are recurring. Processor 404 may prompt the user to designate the operation, here, the streaming service, as exempt.

In some embodiments, the at least one processor (such as, for example, processor 404) may be configured to receive an operation amount threshold, the operation amount threshold being configured to exempt operations of an amount lower than the operation amount threshold from requiring user approval. The operation amount threshold may refer to a set dollar amount associated with an operation. In some embodiments, the operation amount threshold may be set at a designated operation amount. In some embodiments, the operation amount threshold may be set by a user, such as, for example, user 414, and may be any dollar amount. For example, the operation amount threshold may be $5, $10, $50, $100, or any other dollar amount set by the user. In some embodiments, the operation amount threshold may be set by an employee administrator. In some embodiments processor 404 may set the operation amount threshold based on the user's operation history. For example, processor 404 may be configured to aggregate all operations a user makes over a certain time period, for example, one month. In this example, processor 404 may set the operation amount threshold as a fraction of the operation amount over a given time period. Here, a user may make $500 worth of operations in a given month. Processor 404 may be configured to set the operation amount threshold as 1% of the monthly operation amounts. Here, processor 404 may therefore set the operation amount threshold at $5.

In some embodiments, when an operation's value is lower than the operation amount threshold, processor 404 may exempt the operation from user approval. For example, a user could set the operation amount threshold to $5.00 and any operation under $5.00 would then be exempt such that no user approval or user identity verification may be required to complete the operation.

In some embodiments, the pending operation information may include at least one of one or more operating party names, a pending operation amount, a pending operation location, and/or a pending operation time. An operating party name may be the name of the party opposite a user. For example, the operating party may be an e-commerce site, an individual online merchant, and/or an in-person merchant. The operating party may also be a bad actor or fraudster posing as a legitimate e-commerce site, individual online merchant, or in-person merchant. A pending operation amount may be the amount of money being exchanged by the user in an operation. A pending operation location may be the geographical location the pending operation is being made from. A pending operation time may be the time at which the pending operation was initiated. In some embodiments, the pending operation information may correspond to a secure operation device and may include at least one pending operation. The at least one pending operation may be an operation that has not yet been approved or disapproved. The at least one single pending operation may be referred to throughout the specification as a pending operation or pending operations.

In some embodiments, a user (such as, for example, user 414, as described with respect to FIG. 4) may share the information corresponding to a secure operation device (such as, for example, secure operation device 416) with a third party so that both the user 405 and the third party may use the operation device. For example, a parent could share debit card information with a child so that the child and the parent can both make operations with the debit card.

In some embodiments, a secure operation device may be co-owned by more than one party. In some embodiments, each of the parties may have a copy of the secure operation device but only one or more selected co-owners may have control over operation approval. For example, an adult child could co-own a secure operation device with their elderly parent who suffers from memory loss, and only the adult child may have control over operation approval. In other embodiments, a secure operation device may be co-owned by more than one party, each of the parties may have a copy of the secure operation device, and each of the co-owners may have control over operation approval. For example, spouses may share control over operation approval.

In some embodiments, the pending operation may be a passive operation. A passive operation may be an operation that the user is not making in real-time. For example, a passive operation may be a ghost charge or other unauthorized charge that is charged to the user when the user is not actively making the purchase. As referred to herein, a ghost charge may be any unauthorized passive operation where the user is charged without being alerted of the charge. A passive operation may also refer to a recurring fee, such as a monthly subscription.

In some embodiments, the pending operation may be an active operation. An active operation may be one where the user is engaging in the operation in real-time. For example, an active operation may be buying a coffee at a coffee shop or making a one-time purchase of a product on an online marketplace. In some embodiments, the pending operation may be an active operation made using a physical card. For example, a user buying food using a physical card at a restaurant is an active operation.

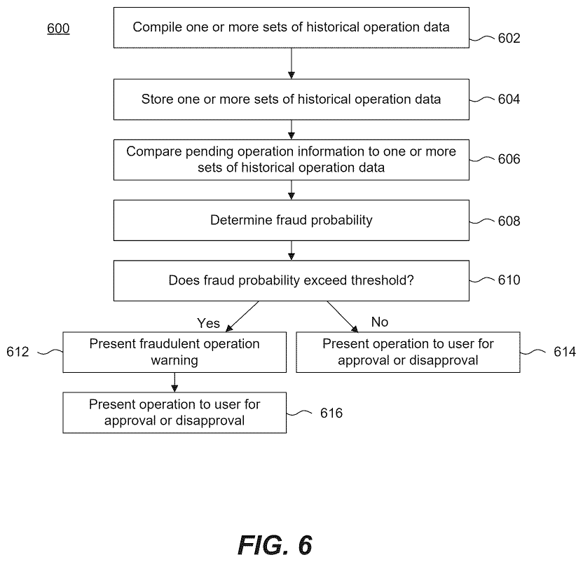

FIG. 6 is a flow chart illustrating exemplary method 600 for flagging approval request (such as, for example, the approval request described in relation to step 506 in method 500, described in FIG. 5) as potentially fraudulent. At least one processor, such as, for example processor 404 described in reference to FIG. 4) may perform the operations disclosed in method 600.

At step 602, the at least one processor may compile one or more sets of historical operation data and store one or more sets of historical operation data in memory 402. In some embodiments, historical operation data may include completed operation data and blocked operation data received from a user over a certain time period. The time period may be configured by the user and/or be preset by the processor. The time period may be one week, one month, one year, five years, or any other time period that accurately captures completed and blocked operation information. Completed operation data may include data such as operation amount, location, date, time, and transacting party names from any operation previously completed by system 400 for preventing fraudulent operations. Processor 404 may be configured to retrieve completed operation data or blocked operation data from memory 402. Blocked operation data may include data such as operation amount, location, date, time, and transacting party names from any operation previously blocked by system 400. At step 604, the processor may store one or more sets of historical operation data in memory 402.

At step 606, the at least one processor may compare one or more sets of pending operation information (such as, pending operation information 406) to the stored historical operation data. In some embodiments, pending operation information 406 may correspond to one or more pending operations. At step 608, the at least one processor may be configured to compare pending operation information 406 and historical operation data to determine fraud probability. Fraud probability may be a score that represents the probability that a pending operation is fraudulent. Fraud probability may be low if the pending operation information 406 is similar to operation data from completed operations or dissimilar to blocked pending operations from the historical data set. Fraud probability may be high if pending operation information 410 is dissimilar to approved operation data or similar to disapproved operation data from historical operation data. In one example, processor 404 may be configured to calculate fraud probability based on pending operation information (such as, for example, pending operation information 406) by retrieving from memory 402 approved operation data or disapproved operation data from historical data set and comparing the pending operation information 410 to completed operation data or blocked operation data.

At step 610, the processor may determine whether the fraud probability exceeds a fraud probability threshold. As used herein, a fraud probability threshold refers to a numerical value associated with the fraud probability. In one example, the fraud probability may be in the form of a fraud probability score ranging from 1-100. In this example, the fraud probability threshold may be 5, 10, 15, 20, 30, or any integer between 1 and 100. In some embodiments, a pending operation may be flagged as a potentially fraudulent operation if fraud probability reaches and/or exceeds a preset threshold. The preset threshold may be configured by user or processor 404. In one example, processor 404 may set the preset threshold based on a historical data set. Here, processor 404 may be configured to store in memory 402 all operations a user makes. In this example, processor 404 may assign each one of these operations a fraud probability. Processor 404 may store fraud probability associated with each operation in memory 402. Processor 404 may be configured to calculate the average fraud probability based on stored operation data. Based on the calculated average fraud probability, processor 404 may produce a preset threshold. A potential fraudulent operation may be an operation that is similar to one or more previously identified fraudulent operations from disapproved operation data or is dissimilar to previously approved operations from approved operation data.

As a non-limiting example, processor 404 may flag a pending operation as potentially fraudulent because the user has previously denied one or more operations made with the same third-party and the pending operation is therefore similar to disapproved operation data. In another non-limiting example, a pending operation may be flagged as a potentially fraudulent operation because it was made at a geographical location far from where the user normally makes operations and is thus dissimilar to approved operation data. In one embodiment, processor 404 may analyze the IP address associated with the operation and determine that the IP address is not the user's typical IP address, and/or that the IP address is from a location far from the user's typical location. In another example, processor 404 may analyze the geographical location associated with the user's device, such as user device 414.

The processor, such as processor 404, may determine that that the fraud probability exceeds the fraud probability threshold at step 610 in method 600. In response to determining that the fraud probability exceeds the fraud probability threshold, the processor may, at step 612, present a fraudulent operation warning to the user via the user device, such as, for example, user device 412. In some embodiments, fraudulent operation warning may inform the user that one or more pending operations may be fraudulent. In some embodiments, processor 404 may be configured to send approval request along with fraudulent operation warning to the user via user device 412 requesting either approval or disapproval of potential fraudulent operation. Upon presenting the fraudulent operation warning to the user, the processor may present the pending operation to the user for approval or disapproval. Alternatively, the processor may, at step 610, determine that the fraud probability does not exceed the fraud probability threshold. In this scenario, the processor may, at step 614 or step 616, present the pending operation to the user, such as, for example, user 414.

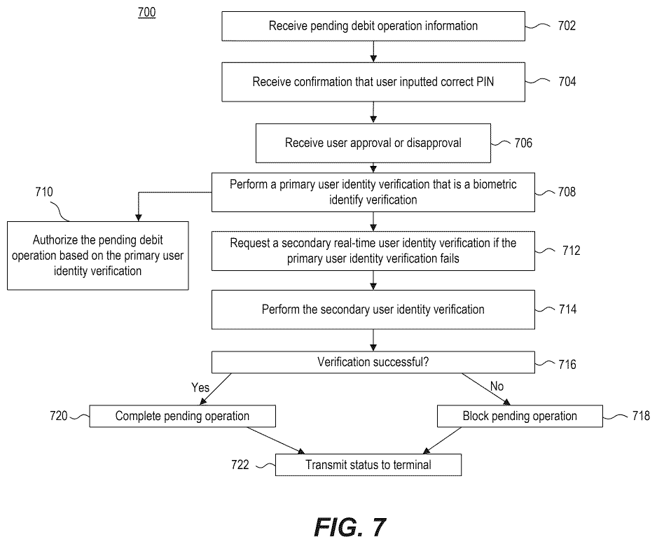

FIG. 7 is a flow chart illustrating an exemplary method 700 for preventing fraudulent debit operations, consistent with disclosed embodiments. At least one processor (such as, for example, processor 404 described in reference to FIG. 4) may perform the operations disclosed in method 700.

At step 702, the processor may receive from terminal 418 pending debit operation information. In some embodiments, a terminal (such as, for example, terminal 418) may receive pending debit operation from a secure operation device (such as, for example, secure operation device 416). Pending debit operation information may be similar to pending operation information 406 but may focus on debit transactions. In some embodiments, pending debit operation information may correspond to a debit card and may comprise a pending debit operation. In a non-limiting example, secure operation device 416 may be a debit card. The debit card may be associated with a secure token, such as, for example, secure token 420 as described and exemplified elsewhere in this disclosure. In some embodiments, pending debit operation may be a passive operation or an active operation. In some embodiments, user (such as, for example, user 414) may input a correct debit Personal Identification Number (PIN) prior to receiving pending debit operation information.

The processor may receive confirmation that the user input their PIN at step 704. In some embodiments, user (such as, for example, user 414) may input the correct debit PIN into a keypad associated with a card reader, such as, for example, terminal 418. In some embodiments, keypad may be a physical keypad. In other embodiments, keypad may be a digital keypad. In some embodiments, a user (such as, for example, user 414) may input the correct debit PIN into keypad associated with terminal 418 for online debit operations. In some embodiments, processor 404 may not send pending debit operation information until user 414 has input the correct debit PIN.

At step 706 (similar to step 508 described in reference to FIG. 5), the at least one processor may receive user approval or disapproval for the pending debit operation. At step 708 (similar to step 510 as described in reference to FIG. 5), the at least one processor (such as, for example, processor 404) may perform a primary real-time user identity verification. At step 710 (similar to step 512 as described in reference to FIG. 5), the at least one processor may authorize the pending debit operation based on the primary real-time user identity verification. At step 712 (similar to step 514 as described in reference to FIG. 5), the at least one processor may request a secondary real-time user identity verification if the primary real-time user identity verification fails. At step 714 (similar to step 516 as described in reference to FIG. 5), the at least one processor may perform the secondary real-time user identity verification. At step 716 (similar to step 518 as described in reference to FIG. 5), the at least one processor may determine whether the verification was successful. If verification is not successful, the at least one processor may block the pending operation at step 718 (similar to step 520 as described in reference to FIG. 5). If verification is successful, the at least one processor may complete the pending operation at step 720 (similar to step 522 as described in reference to FIG. 5). Regardless of whether verification was successful at step 716, the at least one processor may transmit the status of the pending operation to the terminal (such as, for example, terminal 418) at step 722 (similar to step 524 as described in reference to FIG. 5).

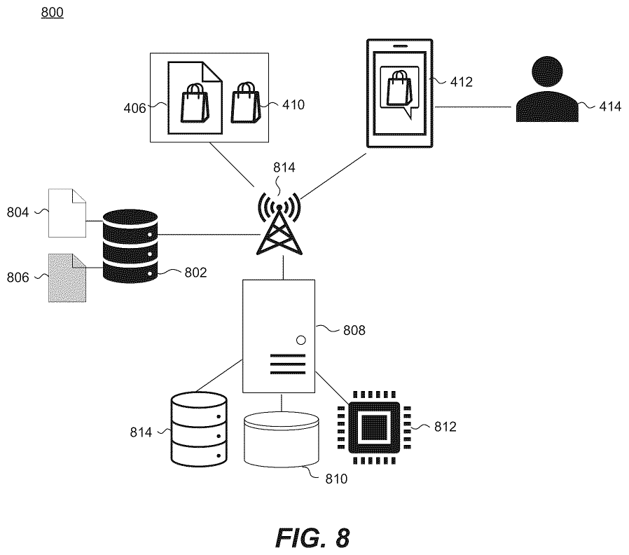

FIG. 8 is a schematic diagram illustrating an exemplary system 800 for fraud prevention. In some embodiments, system 800 includes storage database 802, which may store pending operation information 804. As referred to herein, a storage database may include one or more data repositories that may be distributed over several physical storage devices, e.g., in a cloud-based computing environment. Any storage device may be a network accessible storage device, or a component of the systems or processes described herein. A storage database may be used for storing data structures, data items, metadata, or any information, as further described herein. In some embodiments, storage database 802 may store historical operation data 806. In some embodiments, historical operation data 806 may include at least one of one or more past operating party names, a past pending operation amount, a past operation location, a past operation time, and/or a past operation date. In some embodiments, pending operation information 804 (similar to, for example, pending operation information 406) may include at least one of one or more operating party names, a pending operation amount, a pending operation location, a pending operation time, and/or a pending operation date.

As referred to herein, a server may include one or more dedicated processors and/or memories and may be configured to store files accessible through a network. In some embodiments, system 800 includes server 808, which may receive pending operation information 804 from storage database 802. In some embodiments, server 808 hosts stored instructions 810. In some embodiments, system 800 includes processor 812 and memory 814, wherein the processor may be configured to receive pending operation information 804 and stored instructions 810 from server 808. In some embodiments, stored instructions 810 may instruct processor 812 to execute systems and processes described elsewhere in this disclosure based on pending operation information 406.

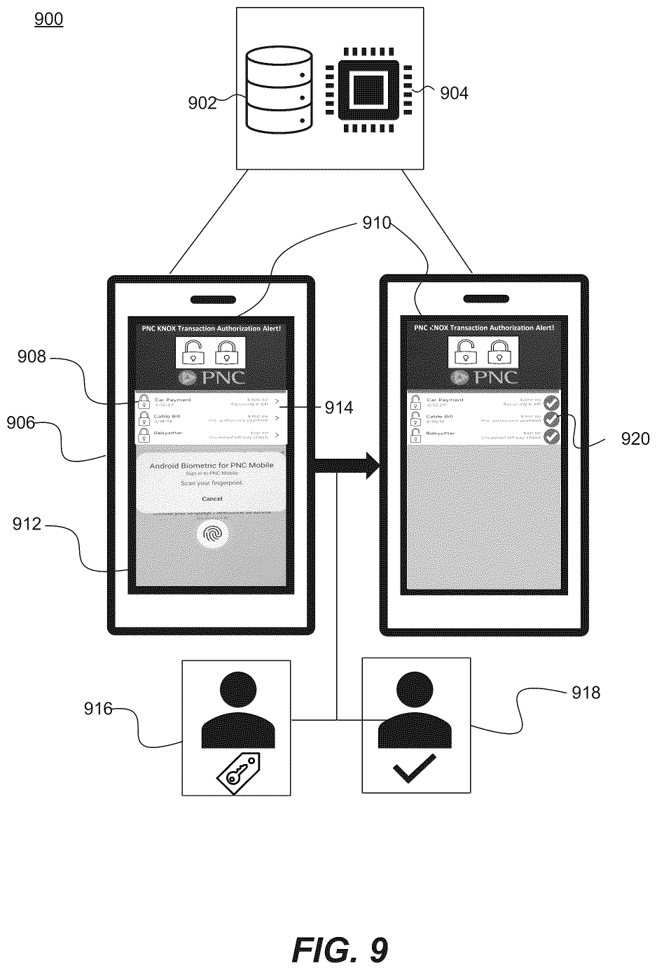

FIG. 9 is an illustration of a user device 902, similar to user device 412 described in reference to FIG. 4. In some embodiments, user device 902 may communicate via an application with a memory and processor, for example memory 902 and processor 904 (similar to memory 402 and processor 404 described in reference to FIG. 4). User device 906 may display one or more approval requests 908 to prompt the user (such as, for example, user 414) to authorize one or more pending operations on user device 906. Approval request 908 may be a push notification displayed on user device 906 that communicates pending operation information (such as, for example, pending operation information 406) and may be selected by the user to indicate operation approval. Approval request 908 may also be communicated to the user via a text notification or via an auditory notification by user device 906. In some embodiments, approval request 908 may be accompanied by one or more operation authorization alerts 910 displayed on user device 906.

In some embodiments, user device 906 may display a pending approval request interface 912. Pending approval request interface 912 may include a list of all pending approval requests 908. In some embodiments, each pending approval request 908 may correspond to at least one single pending operation (such as, for example, pending operation 410). In some embodiments, at least one single pending operation may be selected from the list of all pending approval requests 908 for user approval or disapproval.

In some embodiments, user device 906 may funnel one or more approval requests 908 to pending approval request interface 912. As shown in FIG. 9, in some embodiments, each approval request 908 may include one or more sets of pending operation information such as an operation name, an operation description, an operation initiation date, and an operation amount. For example, one set of pending operation information shown in FIG. 9 is named Car Payment 914, and is described as a Recurring e-bill, was initiated on Apr. 12, 2020, and is for an amount of $400.

In some embodiments, processor 904 may prompt user (such as, for example, user 412) to select one or more approval requests 908. After user 412 selects one or more approval requests 908, processor 904 may be configured to execute user authorization protocol and a user identity verification protocol. In some embodiments, user authorization protocol 916 may include sending a user an approval request input option to user device 906 and receive approval or disapproval from user 412 via the approval request input option. In some embodiments, user authorization protocol 916 may include verifying user identity, as described and exemplified elsewhere in this disclosure. If user authorization protocol 916 results in user approval of one or more approval request 908 and user identity verification protocol 918 verifies user identity, then the at least one single pending operation corresponding to one or more pending approval request may be approved. In response to the approval, the processor may, for example, transfer funds. In some embodiments, processor 904 is configured to not update pending approval user interface 912 until user identity verification protocol 918 verifies user identity. In other words, processor 904 may be configured to lock pending approval interface 912 until the user's identity is verified. Locking pending approval request interface 912 until the user's identify has been verified ensures that no operations—either active or passive—are approved without user input. Prompting the user to approve such operations assists users who are not technologically savvy, such as the elderly and very young, by ensuring that the user does not inadvertently authorize a potentially fraudulent operation.

In some embodiments, user device 906 may display on pending approval request interface 912 an indication that the operation was completed by displaying a completion symbol 920 adjacent to a completed operation. An operation may be completed when funds have been transferred from user to a third party. In one example, processor 904 may be configured to not display this symbol until the user approves the pending operation.

In some embodiments, the pending approval request interface 912 may be accessed via a digital application. In some embodiments, the pending approval request interface 912 may be accessed via a browser on a mobile device, such as user device 906.

In some embodiments, one or more operation authorization alert 910 may include one or more of a visual alert, an audio alert, or a haptic alert. In some embodiments, the visual alert may be a banner notification displayed on a graphical user interface of user device 906.

In some embodiments, the visual alert may include written words that inform a user (such as, for example, user 414) of one or more approval request 908. In some embodiments, the visual alert may include one or more of a graphic, an icon, or an illustration that symbolizes the need for user 414 to complete approval request 908.

In some embodiments, the audio alert may include an audible signal, which may be projected via user device 906. In one example, the audio alert is played via a speaker associated with user device 906. In some embodiments, the audible signal may alert the user of one or more approval request 908. In some embodiments, the audible signal may include a noise that does not contain words such as a ping or a beep. In other embodiments, the audible signal may include one or more words projected from the user device 906. In some embodiments, the one or more words projected from user device 906 may alert the user of one or more approval request 908.

In some embodiments, the haptic alert may include a haptic signal and may be projected by user device 906 for the user (such as, for example, user 414) to feel. The haptic signal may be tactile. In some embodiments the haptic signal may alert the user of one or more approval request 908. In some embodiments, the haptic signal may include one or more vibrations produced by user device 906.

In some embodiments, one or more operation authorization alerts 910 may be a combination of visual, audio, and haptic alerts. For example, in some embodiments, when the one or more operation authorization alerts 910 are presented via user device 906, user device 906 may vibrate, user device 906 may project an audible signal, and/or user device 906 may visually display a banner notification on the graphical user interface of user device 906.

In some embodiments, the user may select one or more pending operations from the list of pending operations in the approval request interface 912 for approval or disapproval.

As used in this disclosure, use of the term “or” in a list of items indicates an inclusive list. The list of items may be prefaced by a phrase such as “at least one of” or “one or more of.” For example, a list of at least one of A, B, or C includes A or B or C or AB (i.e., A and B) or AC or BC or ABC (i.e., A and B and C). Also, as used in this disclosure, prefacing a list of conditions with the phrase “based on” shall not be construed as “based only on” the set of conditions and rather shall be construed as “based at least in part on” the set of conditions. For example, an outcome described as “based on condition A” may be based on both a condition A and a condition B without departing from the scope of this disclosure.

The present disclosure, in connection with the accompanied drawings, describes example configurations that are not representative of all the examples that may be implemented or all configurations that are within the scope of this disclosure. The term “exemplary” should not be construed as “preferred” or “advantageous compared to other examples” but rather “an illustration, an instance or an example.” By reading this disclosure, including the description of the embodiments and the drawings, it will be appreciated by a person of ordinary skills in the art that the technology disclosed herein may be implemented using alternative embodiments. The person of ordinary skill in the art would appreciate that the embodiments, or certain features of the embodiments described herein, may be combined to arrive at yet other embodiments for practicing the technology described in the present disclosure. Thus, the disclosure is not limited to the examples and designs described herein but is to be accorded the broadest scope consistent with the principles and novel features disclosed herein.

The flowcharts and block diagrams in the figures illustrate examples of the architecture, functionality, and operation of possible implementations of systems and methods according to various embodiments. It should be noted that, in some alternative implementations, the functions noted in blocks may occur out of the order noted in the figures. For example, two blocks shown in succession may, in fact, be executed substantially concurrently, or the blocks may sometimes be executed in the reverse order, depending upon the functionality involved. Likewise, additional steps may be included in such methods, and certain steps may be omitted or combined, in methods consistent with various embodiments.

It is to be understood that the described embodiments are not mutually exclusive, and elements, components, materials, or steps described in connection with one example embodiment may be combined with, or eliminated from, other embodiments in suitable ways to accomplish desired design objectives.

Reference herein to “some embodiments” or “some exemplary embodiments” means that a particular feature, structure, or characteristic described in connection with the embodiment can be included in at least one embodiment. The appearance of the phrases “one embodiment” “some embodiments” or “another embodiment” in various places in the present disclosure do not all necessarily refer to the same embodiment, nor are separate or alternative embodiments necessarily mutually exclusive of other embodiments.

Additionally, the articles “a” and “an” as used in the present disclosure and the appended claims should generally be construed to mean “one or more” unless specified otherwise or clear from context to be directed to a singular form.

It is appreciated that certain features of the present disclosure, which are, for clarity, described in the context of separate embodiments, may also be provided in combination in a single embodiment. Conversely, various features of the specification, which are, for brevity, described in the context of a single embodiment, may also be provided separately or in any suitable subcombination or as suitable in any other described embodiment of the specification. Certain features described in the context of various embodiments are not essential features of those embodiments, unless noted as such.

It will be further understood that various modifications, alternatives, and variations in the details, materials, and arrangements of the parts which have been described and illustrated in order to explain the nature of described embodiments may be made by those skilled in the art without departing from the scope. Accordingly, the following claims embrace all such alternatives, modifications, and variations that fall within the terms of the claims.

1-31. (canceled)

32. A system comprising:
at least one memory for storing instructions; and
at least one processor of a server in communication with the at least one memory, the at least one processor configured to execute the stored instructions to:
receive, from a remote server, pending debit operation information, the pending debit operation information corresponding to a debit card and including at least one pending debit operation;
receive, from a remote server, confirmation that a debit card user inputted a correct debit Personal Identification Number (PIN);
cause a user device to present an approval request to authorize at least one pending debit operation;
receive a user input including one of an approval or a disapproval of the approval request;
upon receiving an approval of the approval request, perform a user identity verification to authenticate a user;
authorize the at least one pending debit operation if the real-time user identity verification authenticates the user;
deny the at least one pending debit operation if the user identity verification does not authenticate the user; and
complete the at least one single pending debit operation if the at least one pending debit operation is approved.

33. The system of claim 32, wherein the pending debit operation information includes at least one chosen from the set of: one or more operator names, a pending debit operation amount, a pending debit operation location, a pending debit operation time, or a pending debit operation date.

34. The system of claim 32, wherein the operations further cause the processor to display a pending approval request interface including a list of all pending approval requests, each approval request on the list corresponding to at least one pending debit operation.

35. The system of claim 34, wherein the pending approval request interface is configured to receive selection of at least one pending debit operation from the list of all pending approval requests for approval or disapproval.

36. The system of claim 32, wherein the biometric identity verification includes at least one of a facial recognition scan, a fingerprint scan, a retina scan, an iris scan, or voice recognition.

37. The system of claim 32, wherein the approval request is a push notification on the user device configured to communicate the pending debit operation information to the user.

38. The system of claim 32, wherein the approval request is communicated via a text notification on the user device.

39. The system of claim 32, wherein the approval request is communicated via an auditory notification by the user device.

40. The system of claim 32, wherein the user input is a touch input.

41. The system of claim 32, wherein the user input is an auditory input.

42. The system of claim 32, wherein the at least one pending debit operation is denied if a predetermined operation approval period lapses.

43. The system of claim 32, wherein the at least one pending debit operation is denied if a predetermined user identity verification period lapses.

44. The system of claim 32, wherein the at least one processor designates at least one recurring operation as exempt from requiring user approval based on an operation history.

45. The system of claim 32, wherein the at least one processor is configured to receive an operation amount threshold configured to exempt operations of an amount lower than the operation amount threshold from requiring user approval.

46. A method comprising:
receiving, from a remote server, pending debit operation information, wherein the pending debit operation information corresponds to a debit card and comprises at least one single pending debit operation, wherein a debit card user has already inputted a correct debit Personal Identification Number (PIN);
causing a user device to present an approval request to authorize the at least one single pending debit operation;
receiving a user input either approving or disapproving the approval request;
upon receiving an approval of the approval request, performing a real-time user identity verification, wherein the real-time user identity verification comprises a biometric identity verification;
approving the at least one single pending debit operation based on the real-time user identity verification;
denying the at least one single pending debit operation if real-time user identity verification is not successful; and
completing the at least one single pending debit operation after the at least one single pending debit operation is approved.

47. The method of claim 46, wherein the pending debit operation information includes at least one chosen from the set of: one or more operator names, a pending debit operation amount, a pending debit operation location, a pending debit operation time, or a pending debit operation date.

48. The method of claim 46, further comprising: sending for display on the user device a pending approval request interface including a list of all pending approval requests, each approval request on the list corresponding to at least one pending debit operation.

49. The method of claim 48, wherein the pending approval request interface is configured to receive selection of at least one pending debit operation from the list of all pending approval requests for approval or disapproval.

50. The method of claim 46, wherein the biometric identity verification includes at least one of a facial recognition scan, a fingerprint scan, a retina scan, an iris scan, or voice recognition.

51. The method of claim 46, wherein the approval request is a push notification on the user device configured to communicate the pending debit operation information to the user.

52. The method of claim 46, wherein the approval request is communicated via a text notification on the user device.

53. The method of claim 46, wherein the approval request is communicated via an auditory notification by the user device.

54. The method of claim 46, wherein the user input is a touch input.

55. The method of claim 46, wherein the user input is an auditory input.

56. The method of claim 46, wherein the at least one pending debit operation is denied if a predetermined operation approval period lapses.

57. The method of claim 46, wherein the at least one pending debit operation is denied if a predetermined user identity verification period lapses.

58. The method of claim 46, further comprising: designating at least one recurring operation as exempt from requiring user approval based on an operation history.

59. The method of claim 46, further comprising: receiving an operation amount threshold configured to exempt operations of an amount lower than the operation amount threshold from requiring user approval.
